(19) United States
(12) Patent Application Publication
(10) Pub. No.: US 2023/0236457 A1
(43) Pub. Date: Jul. 27, 2023

(54) METHODS FOR MANUFACTURING A LIQUID CRYSTAL DEVICE COMPRISING AN INTERSTITIAL SUBSTRATE

(71) Applicant: CORNING INCORPORATED, CORNING, NY (US)

(72) Inventors: Thomas Bertin-Mourot, Paris (FR); Douglas Llewellyn Butler, Painted Post, NY (US); Mingqian He, Horseheads, NY (US); Andrii Varanytsia, Sunnyvale, CA (US); Yu-Chieh Wang, Taichung City (TW)

(21) Appl. No.: 18/011,268

(22) PCT Filed: Apr. 16, 2021
(86) PCT No.: PCT/US2021/027656

§ 371 Date: Dec. 19, 2022

Related U.S. Application Data
(60) Provisional application No. 63/046,941, filed on Jul. 1, 2020.
(60) Provisional application No. 63/051,088, filed on Jul. 13, 2020.

(51) Int. Cl. G02F 1/1337; G02F 1/1339

(52) U.S. Cl. CPC G02F 1/133796; G02F 1/133784; G02F 1/13392

(57) ABSTRACT

Disclosed are methods for manufacturing liquid crystal devices including at least two liquid crystal layers and at least one interstitial substrate separating the liquid crystal layers. Methods for processing, assembling, and singulating liquid crystal devices are also disclosed.

### CROSS-REFERENCE TO RELATED APPLICATIONS

This application claims the benefit of priority under 35 U.S.C. § 371 of International Application No. PCT/US2021/027656, filed on Apr. 16, 2021, which claims the benefit of priority under 35 U.S.C. § 119 of U.S. Provisional Application No. 63/046,941, filed Jul. 1, 2020, and U.S. Provisional Application No. 63/051,088, filed Jul. 13, 2020, the content of each of which is incorporated herein by reference in its entirety.

### FIELD OF THE DISCLOSURE

The disclosure relates generally to methods for manufacturing liquid crystal devices comprising at least one interstitial substrate, and more particularly to methods for making liquid crystal windows comprising at least two liquid crystal layers separated by an interstitial substrate.

### BACKGROUND

Liquid crystal devices are used in various architectural and transportation applications, such as windows, doors, space partitions, and skylights for buildings and automobiles. For many commercial applications, it is desirable for liquid crystal devices to provide high contrast ratio between the on and off states while also providing good energy efficiency and cost effectiveness. Higher contrast ratio can be achieved using greater amounts of liquid crystal material and/or light absorbing additives. However, as the layer of liquid crystal becomes thicker, it becomes harder to control the orientation of the crystals, which can negatively impact the optical effectiveness and contrast ratio of the overall device. As such, achieving a high contrast ratio using a single liquid crystal cell design has been challenging to date.

Liquid crystal devices including a double cell structure, e.g., two side-by-side liquid crystal cell units, have conventionally been used to obtain desired high contrast ratios. However, double cell structures also have various drawbacks, such as increased overall weight and thickness of the unit and higher manufacturing cost and complexity due to the presence of additional glass layers and electrode components. The additional glass interfaces may also result in optical losses across the double cell structure.

As such, there is a need for lighter and/or thinner liquid crystal devices that provide an acceptable contrast ratio for commercial applications. It would also be advantageous to provide manufacturing methods that reduce the cost and/or complexity of producing such a liquid crystal device.

### SUMMARY

The disclosure relates, in various embodiments, to methods for making a liquid crystal device, the methods comprising: (a) producing a first substrate assembly by: (i) depositing a first electrode layer on a first surface of a first glass substrate, and (ii) depositing a first alignment layer on the first electrode layer; (b) producing a second substrate assembly by: (i)

depositing a second electrode layer on a first surface of a second glass substrate, and (ii) depositing a second alignment layer on the second electrode layer; (c) producing a third substrate assembly by: (i) depositing a third alignment layer on a first surface of a third substrate, and (ii) depositing a fourth alignment layer on an opposing second surface of the third substrate; (d) producing a half-cell assembly by: (i) bringing the first substrate assembly and the third substrate assembly into proximity to define a first cell gap, wherein the first and third substrate assemblies are positioned such that the first alignment layer and third alignment layers face each other; (ii) filling the first cell gap with liquid crystal material to form a first liquid crystal layer, and (iii) sealing the first liquid crystal layer; (e) producing a liquid crystal assembly by: (i) bringing the second substrate assembly and the half-cell assembly into proximity to define a second cell gap, wherein the second substrate assembly and half-cell assembly are positioned such that the second alignment layer and fourth alignment layers face each other; (ii) filling the second cell gap with liquid crystal material to form a second liquid crystal layer, and (iii) sealing the second liquid crystal layer; and (f) singulating the liquid crystal assembly to produce at least one liquid crystal device.

In non-limiting embodiments, the method further comprises patterning at least one of the first and second electrode layers. The method can additionally comprise rubbing at least one of the first, second, third, and fourth alignment layers to create surface anisotropy. The steps of depositing the third and fourth alignment layers on the third substrate can be carried out sequentially or simultaneously. Rubbing the fourth alignment layer to create surface anisotropy may be performed, in some embodiments, subsequent to the step (d) of producing the half-cell assembly and prior to the step (e) of producing the liquid crystal assembly.

According to various embodiments, the method further comprises depositing a third electrode layer on the first surface of the third substrate prior to depositing the third alignment layer and depositing a fourth electrode layer on the second surface of the third substrate prior to depositing the fourth alignment layer. In certain embodiments, at least one of steps (d) and (e) further comprises applying spacers to define a thickness of the first or second liquid crystal layer. According to additional embodiments, at least one of steps (d) and (e) further comprises applying an adhesive to at least one of the first, second, or third substrates to define an edge seal perimeter and curing the adhesive to seal the first or second liquid crystal layer. In certain embodiments, the method can further comprise curing at least one of the first and second liquid crystal layers.

According to various embodiments, singulating the liquid crystal assembly comprises separating the liquid crystal assembly from a motherboard glass assembly. In additional embodiments, singulating the liquid crystal assembly comprises removing at least a portion of at least one of the first, second, or third substrates to define at least one recessed edge in the liquid crystal device. In further embodiments, singulating the liquid crystal assembly comprises at least one of laser cutting and scribe and break techniques. According to non-limiting embodiments, the method can also comprise wire bonding the liquid crystal device to connect at least one of the first and second electrode layers to a power source.

Also disclosed herein are methods for making a liquid crystal device, the methods comprising: (a) producing a first substrate assembly by depositing a first alignment layer on a first surface of a first glass substrate; (b) producing a second substrate assembly by depositing a second alignment layer on a first surface of a second glass substrate; (c) producing a third substrate assembly by: (i) depositing a first electrode layer on a first surface of a third substrate, (ii) depositing a third alignment layer on the first electrode layer, (iii) depositing a second electrode layer on an opposing second surface of the third substrate, and (ii) depositing a fourth alignment layer on the second electrode layer; (d) producing a half-cell assembly by: (i) bringing the first substrate assembly and the third substrate assembly into proximity to define a first cell gap, wherein the first and third substrate assemblies are positioned such that the first alignment layer and third alignment layers face each other; (ii) filling the first cell gap with liquid crystal material to form a first liquid crystal layer, and (iii) sealing the first liquid crystal layer; (e) producing a liquid crystal assembly by: (i) bringing the second substrate assembly and the half-cell assembly into proximity to define a second cell gap, wherein the second substrate assembly and half-cell assembly are positioned such that the second alignment layer and fourth alignment layers face each other; (ii) filling the second cell gap with liquid crystal material to form a second liquid crystal layer, and (iii) sealing the second liquid crystal layer; and (f) singulating the liquid crystal assembly to produce at least one liquid crystal device.

Further disclosed herein are methods for making a liquid crystal device, the methods comprising: (a) producing a first substrate assembly by: (i) depositing a first electrode layer on a first surface of a first glass substrate, and (ii) depositing a first alignment layer on the first electrode layer; (b) producing a second substrate assembly by: (i) depositing a second electrode layer on a first surface of a second glass substrate, and (ii) depositing a second alignment layer on the second electrode layer; (c) producing a third substrate assembly by depositing a third alignment layer on a first surface of a third substrate, and (d) producing a half-cell assembly by: (i) bringing the first substrate assembly and the third substrate assembly into proximity to define a first cell gap, wherein the first and third substrate assemblies are positioned such that the first alignment layer and third alignment layers face each other; (ii) filling the first cell gap with liquid crystal material to form a first liquid crystal layer, and (iii) sealing the first liquid crystal layer; (e) modifying the half-cell assembly by depositing a fourth alignment layer on a second surface of the third substrate; (f) producing a liquid crystal assembly by: (i) bringing the second substrate assembly and the modified half-cell assembly into proximity to define a second cell gap, wherein the second substrate assembly and half-cell assembly are positioned such that the second alignment layer and fourth alignment layers face each other; (ii) filling the second cell gap with liquid crystal material to form a second liquid crystal layer, and (iii) sealing the second liquid crystal layer; and (g) singulating the liquid crystal assembly to produce at least one liquid crystal device.

Still further disclosed herein are methods for making a liquid crystal device, the methods comprising: (a) producing a first substrate assembly by depositing a first alignment layer on a first surface of a first glass substrate; (b) producing a second substrate assembly by depositing a second alignment layer on a first surface of a second glass substrate; (c) producing a third substrate assembly by: (i) depositing a first electrode layer on a first surface of a third substrate, and (ii) depositing a third alignment layer on the first electrode layer, (d) producing a half-cell assembly by: (i) bringing the first substrate assembly and the third substrate assembly into proximity to define a first cell gap, wherein the first and third substrate assemblies are positioned such that the first alignment layer and third alignment layers face each other; (ii) filling the first cell gap with liquid crystal material to form a first liquid crystal layer, and (iii) sealing the first liquid crystal layer; (e) modifying the half-cell assembly by: (i) depositing a second electrode layer on a second surface of the third substrate, and (ii) depositing a fourth alignment layer on the second electrode layer; (f) producing a liquid crystal assembly by: (i) bringing the second substrate assembly and the modified half-cell assembly into proximity to define a second cell gap, wherein the second substrate assembly and half-cell assembly are positioned such that the second alignment layer and fourth alignment layers face each other; (ii) filling the second cell gap with liquid crystal material to form a second liquid crystal layer, and (iii) sealing the second liquid crystal layer; and (g) singulating the liquid crystal assembly to produce at least one liquid crystal device.

Additional features and advantages of the disclosure will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework for understanding the nature and character of the claims. The accompanying drawings are included to provide a further understanding of the disclosure and are incorporated into and constitute a part of this specification. The drawings illustrate various embodiments of the disclosure and together with the description serve to explain the principles and operations of the various embodiments.

### BRIEF DESCRIPTION OF THE DRAWINGS

The following detailed description can be further understood when read in conjunction with the following drawings. Whenever possible, the same reference numerals will be used throughout the drawings to refer to the same or like parts. It is to be understood that the figures are not drawn to scale and the size of each depicted component or the relative size of one component to another is not intended to be limiting.

FIG. 1 depicts a process flow diagram for an exemplary manufacturing method according to various embodiments of the disclosure;

FIG. 2 depicts a process flow diagram for an exemplary manufacturing method according to additional embodiments of the disclosure;

FIG. 3 depicts a process flow diagram for an exemplary manufacturing method according to further embodiments of the disclosure;

FIGS. 4A-B depict non-limiting embodiments of motherboard glass substrates comprising multiple liquid crystal units;

FIG. 5 depicts a method for singulating liquid crystal devices according to certain embodiments of the disclosure;

FIG. 6 depicts a method for singulating liquid crystal devices according to alternative embodiments of the disclosure

FIG. 7 depicts a method for singulating liquid crystal devices according to additional embodiments of the disclosure

FIG. 8 depicts a method for singulating liquid crystal devices according to further embodiments of the disclosure; and

FIG. 9 depicts a method for singulating liquid crystal devices according to still further embodiments of the disclosure.

### DETAILED DESCRIPTION

Disclosed herein are methods for manufacturing liquid crystal devices including at least two liquid crystal layers and at least one interstitial substrate separating the liquid crystal layers. Methods for processing, assembling, and singulating liquid crystal devices are also disclosed herein.

Liquid Crystal Devices

The methods disclosed herein can be used to manufacture and/or assemble, e.g., liquid crystal devices and liquid crystal windows. For example, the liquid crystal devices can comprise: a first substrate assembly comprising a first glass substrate, a first alignment layer, and a first electrode layer disposed therebetween; a second substrate assembly comprising a second glass substrate, a second alignment layer, and a second electrode layer disposed therebetween; a third substrate assembly comprising a third alignment layer, a fourth alignment layer, and a third substrate disposed therebetween; a first liquid crystal layer disposed between the first substrate assembly and the third substrate assembly; and a second liquid crystal layer disposed between the second substrate assembly and the third substrate assembly.

Non-limiting liquid crystal devices may also comprise: a first substrate assembly comprising a first glass substrate and a first alignment layer; a second substrate assembly comprising a second glass substrate and a second alignment layer; a third substrate assembly comprising a third alignment layer, a fourth alignment layer, a first electrode layer, a second electrode layer, and a third substrate; a first liquid crystal layer disposed between the first substrate assembly and the third substrate assembly; and a second liquid crystal layer disposed between the second substrate assembly and the third substrate assembly.

Additional examples of liquid crystal devices can comprise: a first substrate assembly comprising a first glass substrate, a first electrode layer, and, optionally, a first alignment layer; a second substrate assembly comprising a second glass substrate, a second electrode layer, and optionally, a second alignment layer; a third substrate assembly comprising a third substrate and, optionally, one or both of a third alignment layer and a fourth alignment layer; a first liquid crystal layer disposed between the first substrate assembly and the third substrate assembly; and a second liquid crystal layer disposed between the second substrate assembly and the third substrate assembly.

Further examples of liquid crystal devices may comprise: a first substrate assembly comprising a first glass substrate, a first alignment layer, and a first electrode disposed therebetween; a second substrate assembly comprising a second glass substrate, a second alignment layer, and a second electrode disposed therebetween; a third substrate assembly comprising a third alignment layer, a fourth alignment layer, a third electrode layer, a fourth electrode layer, and a third substrate, wherein the third electrode layer is disposed between the third substrate and the third alignment layer, and wherein the fourth electrode layer is disposed between the third substrate and the fourth alignment layer; a first liquid crystal layer disposed between the first substrate assembly and the third substrate assembly; and a second liquid crystal layer disposed between the second substrate assembly and the third substrate assembly.

Still further examples of liquid crystal devices can comprise: a first substrate assembly comprising a first glass substrate, a first electrode layer, and, optionally, a first alignment layer; a second substrate assembly comprising a second glass substrate a second electrode layer, and, optionally, a second alignment layer; a third substrate assembly comprising a third electrode layer, a fourth electrode layer, a third substrate, and, optionally, one or both of a third alignment layer and a fourth alignment layer; a first liquid crystal layer disposed between the first substrate assembly and the third substrate assembly; and a second liquid crystal layer disposed between the second substrate assembly and the third substrate assembly.

Non-limiting liquid crystal devices may also comprise: a first substrate assembly comprising a first glass substrate, a first alignment layer, and a first electrode layer disposed therebetween; a second substrate assembly comprising a second glass substrate and a second electrode layer; a third substrate assembly comprising a third alignment layer, a third electrode layer, a fourth electrode layer, and a third substrate, wherein the third electrode layer is disposed between the third substrate and the third alignment layer, and wherein the third substrate is disposed between the third electrode layer and the fourth electrode layer; a liquid crystal layer disposed between the first substrate assembly and the third substrate assembly; and an electrochromic layer disposed between the second substrate assembly and the third substrate assembly.

The methods disclosed herein can also be used to manufacture and/or assemble liquid crystal windows comprising any liquid crystal device disclosed above and a glass substrate separated from the liquid crystal device by a sealed gap.

Materials

Substrates

The methods disclosed herein can comprise one or more assembly steps for arranging at least one interstitial (e.g., third and/or fourth) substrate between two outer (e.g., first and second) substrates. Each substrate may be part of a substrate assembly which can include, for example, at least one of an alignment layer or an electrode layer.

The first substrate may be referred to interchangeably herein as an “outer” substrate or “Substrate A” and the corresponding substrate assembly including the first substrate may be referred to interchangeably herein as a “first” substrate assembly, an “outer” substrate assembly or substrate assembly “A.” Similarly, the second substrate may be referred to interchangeably herein as an “outer” substrate or “Substrate C” and the corresponding substrate assembly including the second substrate may be referred to interchangeably herein as a “second” substrate assembly, an “outer” substrate assembly or substrate assembly “C.”

The third substrate may be referred to interchangeably herein as an “interstitial” substrate or “Substrate B” and the corresponding substrate assembly including the third substrate may be referred to interchangeably herein as a “first” substrate assembly, an “interstitial” substrate assembly or substrate assembly “B.” Similarly, the fourth substrate, if present, may be referred to interchangeably herein as an “interstitial” substrate or “Substrate D” and the corresponding substrate assembly including the fourth substrate may be referred to interchangeably herein as a “fourth” substrate assembly, an “interstitial” substrate assembly or substrate assembly “D.”

According to non-limiting embodiments, at least one of the outer (e.g., first and second) substrates and/or interstitial (e.g., third and fourth) substrates, may comprise an optically transparent material. As used herein, the term “optically transparent” is intended to denote that the component and/or layer has a transmission of greater than about 80% in the visible region of the spectrum (˜400-700 nm). For instance, an exemplary component or layer may have greater than about 85% transmittance in the visible light range, such as greater than about 90%, or greater than about 95%, including all ranges and subranges therebetween. In certain embodiments, all of the substrates comprise an optically transparent material.

In non-limiting embodiments, the first and second substrates may comprise optically transparent glass sheets. The first and second substrates can have any shape and/or size, such as a rectangle, square, or any other suitable shape, including regular and irregular shapes and shapes with one or more curvilinear edges. According to various embodiments, the first and second substrates can have a thickness of less than or equal to about 4 mm, for example, ranging from about 0.1 mm to about 4 mm, from about 0.2 mm to about 3 mm, from about 0.3 mm to about 2 mm, from about 0.5 mm to about 1.5 mm, or from about 0.7 mm to about 1 mm, including all ranges and subranges therebetween. In certain embodiments, the first and second substrates can have a thickness of less than or equal to 0.5 mm, such as 0.4 mm, 0.3 mm, 0.2 mm, or 0.1 mm, including all ranges and subranges therebetween. In non-limiting embodiments, the glass substrates can have a thickness ranging from about 1 mm to about 3 mm, such as from about 1.5 to about 2 mm, including all ranges and subranges therebetween. The first and second substrates may, in some embodiments, comprise the same thickness, or may have different thicknesses.

The first and second substrates may comprise any glass known in the art, for example, soda-lime silicate, aluminosilicate, alkali-aluminosilicate, borosilicate, alkaliborosilicate, aluminoborosilicate, alkali-aluminoborosilicate, and other suitable display glasses. The first and second glass substrates may, in some embodiments, comprise the same glass, or may be different glasses. The first and second substrates may, in various embodiments, be chemically strengthened and/or thermally tempered. Non-limiting examples of suitable commercially available glasses include EAGLE XG®, Lotus™, Willow®, and Gorilla® glasses from Corning Incorporated, to name a few. Chemically strengthened glass, for example, may be provided in accordance with U.S. Pat. Nos. 7,666,511, 4,483,700, and 5,674,790, which are incorporated herein by reference in their entireties.

According to various embodiments, the first and second substrates may be chosen from glass sheets produced by a fusion draw process. Without wishing to be bound by theory, it is believed that the fusion draw process can provide glass sheets with a relatively low degree of waviness (or high degree of flatness), which may be beneficial for various liquid crystal applications. An exemplary glass substrate may thus, in certain embodiments, comprise a surface waviness of less than about 100 nm as measured with a contact profilometer, such as about 80 nm or less, about 50 nm or less, about 40 nm or less, or about 30 nm or less, including all ranges and subranges therebetween. An exemplary standard technique for measuring waviness (0.8-8 mm) with a contact profilometer is outlined in SEMI D15-1296 “FPD Glass Substrate Surface Waviness Measurement Method.”

The third substrate and, if present, fourth substrate, as well as any other interstitial substrates that might be present in the liquid crystal device, can comprise a glass material as discussed above with reference to first and second substrates. In some embodiments, the outer (e.g., first and second) substrates and the interstitial (e.g., third and fourth substrates) may all comprise a glass material, which can be the same or different glass materials. According to other embodiments, the interstitial substrates such as the third and fourth substrates may comprise a material other than glass, such as plastics and ceramics, including glass ceramics. Suitable plastic materials include, but are not limited to, polycarbonates, polyacrylates such as polymethylmethacrylate (PMMA), and polyethyelenes such as polyethylene terephthalate (PET). The third and fourth substrates (as well as any other interstitial substrates) may, in some embodiments, comprise the same material, or may be different materials.

The third substrate and, if present, the fourth substrate, as well as any other interstitial substrate that might be present in the liquid crystal device, can have any shape and/or size, such as a rectangle, square, or any other suitable shape, including regular and irregular shapes and shapes with one or more curvilinear edges. According to various embodiments, the third and fourth substrates can have a thickness of less than or equal to about 4 mm, for example, ranging from about 0.005 mm to about 4 mm, from about 0.01 mm to about 3 mm, from about 0.02 mm to about 2 mm, from about 0.05 mm to about 1.5 mm, from about 0.1 mm to about 1 mm, from about 0.2 mm to about 0.7 mm, or from about 0.3 mm to about 0.5 mm, including all ranges and subranges therebetween. In certain embodiments, the interstitial substrates can have a thickness of less than or equal to 0.5 mm, such as 0.4 mm, 0.3 mm, 0.2 mm, 0.1 mm, 0.05 mm, 0.02 mm, 0.01 mm, or less, including all ranges and subranges therebetween. Third and fourth substrates (as well as any other interstitial substrates) may, in some embodiments, comprise the same thickness, or may have different thicknesses.

According to further embodiments, the interstitial substrate(s) may comprise a highly conductive transparent material, for instance, a material having an electrical conductivity of at least about 10⁻⁵ S/m, at least about 10⁻⁴ S/m, at least about 10⁻³ S/m, at least about 10⁻² S/m, at least about 0.1 S/m, at least about 1 S/m, at least about 10 S/m, or at least about 100 S/m, e.g., ranging from 0.0001 S/m to about 1000 S/m, including all ranges and subranges therebetween.

Alignment Layers

The methods disclosed herein can comprise one or more assembly steps for coating at least one surface of the substrates and/or electrode layers with at least one alignment layer. Alignment layers may, in certain instances, be referred to herein using the reference symbol “AL.” The individual alignment layers used to manufacture the liquid crystal device may, in some embodiments, comprise the same or different materials, the same or different thicknesses, and the same or different orientations relative to one another.

Alignment layers can comprise a thin film of material having a surface energy and anisotropy promoting the desired orientation for the liquid crystals in direct contact with its surface. Exemplary materials include, but are not limited to, main chain or side chain polyimides, which can be mechanically rubbed to generate layer anisotropy; photosensitive polymers, such as azobenzene-based compounds, which can be exposed to linearly polarized light to generate surface anisotropy; and inorganic thin films, such as silica, which can be deposited using thermal evaporating techniques to form periodic microstructures on the surface.

According to various embodiments, the alignment layers can have a thickness of less than or equal to about 100 nm, for example, ranging from about 1 nm to about 100 nm, from about 5 nm to about 90 nm, from about 10 nm to about 80 nm, from about 20 nm to about 70 nm, from about 30 nm to about 60 nm, or from about 40 nm to about 50 nm, including all ranges and subranges therebetween.

Electrode Layers

The methods disclosed herein can comprise one or more assembly steps for positioning at least one electrode layer in various locations within the liquid crystal device. Electrode layers may, in certain instances, be referred to herein using the reference symbol “EL.” The individual electrode layers used to manufacture the liquid crystal device may comprise the same or different materials, the same or different thicknesses, and the same or different patterns.

Electrode layers in the liquid crystal device may comprise one or more transparent conductive oxides (TCOs), such as indium tin oxide (ITO), indium zinc oxide (IZO), gallium zinc oxide (GZO), aluminum zinc oxide (AZO), and other like materials. Alternatively, the electrode layers may comprise other transparent materials, such as a conductive mesh, e.g., comprising metals such as silver nanowires or other nanomaterials such as graphene or carbon nanotubes. Printable conductive ink layers such as ActiveGrid™ from C3Nano Inc. may also be used. According to various embodiments, the sheet resistance (e.g., as measured in ohms-per-square) of the electrode layers can range from about 10Ω/□ (ohms/square) to about 1000Ω/□, such as from about 50Ω/□ to about 900Ω/□, from about 100Ω/□ to about 800Ω/□, from about 200Ω/□ to about 700Ω/□, from about 300Ω/□ to about 600Ω/□, or from about 400Ω/□ to about 500Ω/□, including all ranges and subranges therebetween.

The electrode layers can, in some embodiments, be deposited on an interior surface of the outer (e.g., first and second) substrates. Electrode layers can also be deposited on opposing surfaces of the interstitial (e.g., third or fourth) substrates. The thickness of each electrode layer can, for example, independently range from about 1 nm to about 1000 nm such as from about 5 nm to about 500 nm, from about 10 nm to about 300 nm, from about 20 nm to about 200 nm, from about 30 nm to about 150 nm, or from about 50 nm to about 100 nm, including all ranges and subranges therebetween. In various embodiments, electrode layers can be deposited on both the interior surfaces of the outer substrates and on opposing surfaces of the interstitial substrate, i.e., two pairs of electrodes. The electrode layers on the interstitial substrate can be “shorted” or electrically linked to one another. In such embodiments, the thickness of the electrode layers deposited on the interstitial substrate may be less than the thickness of the electrode layers deposited on the outer substrates, which can lower material costs and/or processing time.

According to various embodiments, the electrode layers may include interdigitated electrode layers. Interdigitated electrode layers comprise a pair of electrodes on a single surface that are energized with different voltages. Liquid crystal layer(s) can be controlled by interdigitated electrodes using In Plane Switching (IPS). An electric field starts at the higher voltage interdigitated electrode, travels through any surrounding media (such as an adjacent liquid crystal layer), and terminates at the lower voltage interdigitated electrode. The location of the interdigitated electrode layers may not be limited only to the outer substrate assemblies. For example, interdigitated electrode layers may alternatively be part of the interstitial substrate assembly.

In non-limiting embodiments, the electrode layers can comprise a pattern, such that they produce desired zones or pixels to allow the switching of the entire liquid crystal device or only a desired portion of the device. For instance, the electrode layers can be patterned to form a plurality of lines or stripes having a vertical or horizontal orientation. Such a pattern can be used to configure, e.g., window transmission similar to mechanical shades by turning on alternating stripes or by setting adjacent electrode stripes to different transmission intensities. Alternative patterns are possible and envisioned as falling within the scope of this disclosure, such as a matrix of square or rectangular pixels, which can be used to configure, e.g., window transmission to provide an arbitrary pattern. The width of the patterned lines and/or pixels can range, in various embodiments, from about 1 mm to about 500 mm, such as from about 2 mm to about 400 mm, from about 3 mm to about 300 mm, from about 5 mm to about 200 mm, from about 10 mm to about 100 mm, or from about 20 mm to about 50 mm, including all ranges and subranges therebetween.

Liquid Crystal Layers

The methods disclosed herein can comprise one or more assembly steps for providing at least two liquid crystal layers disposed between the outer substrates and interstitial substrates. The individual liquid crystal layers in the device may comprise the same or different liquid crystal materials and/or additives, the same or different thicknesses, the same or different switching modes, and the same or different orientations relative to one another.

The orientation of liquid crystal material can be described by a unit vector, referred to herein as a “director,” which represents the average local orientation of the long molecular axes of the liquid crystal molecules. The substrates in the liquid crystal device can have a surface energy promoting the desired alignment of the liquid crystal director in a ground or “off” state without applied voltage. A vertical or homeotropic alignment is achieved when the liquid crystal director has a perpendicular or substantially perpendicular orientation with respect to the plane of the substrate. A planar or homogeneous alignment is achieved when the liquid crystal director has a parallel or substantially parallel orientation with respect to the plane of the substrate. An oblique alignment is achieved when the liquid crystal direction has a large angle with respect to the plane of the substrate, which is substantially different from planar or homeotropic, i.e., ranging from about 20° to about 70°, such as from about 30° to about 60°, or from about 40° to about 50°, including all ranges and subranges therebetween.

A liquid crystal layer can comprise liquid crystals and one or more additional components, such as dyes or other coloring agents, chiral dopants, polymerizable reactive monomers, photoinitiators, polymerized structures, or any combination thereof. The liquid crystals can have any liquid crystal phase, such as achiral nematic liquid crystal (NLC), chiral nematic liquid crystal, cholesteric liquid crystal (CLC), or smectic liquid crystal, which are operable over a broad range of temperatures, such as from about −40° C. to about 110° C.

According to various embodiments, the liquid crystal layers can comprise a cell gap or cavity that is filled with liquid crystal material. The thickness of the liquid crystal layer, or the cell gap distance, can be maintained by particle spacers and/or columnar spacers dispersed in the liquid crystal layer. The liquid crystal layers can have a thickness of less than or equal to about 0.2 mm, for example, ranging from about 0.001 mm to about 0.1 mm, from about 0.002 mm to about 0.05 mm, from about 0.003 mm to about 0.04 mm, from about 0.004 mm to about 0.03 mm, from about 0.005 mm to about 0.02 mm, or from about 0.01 mm to about 0.015 mm, including all ranges and subranges therebetween. The individual liquid crystal layers in the device may all comprise the same thickness or may have different thicknesses.

Any liquid crystal switching mode known in the art can be used, such as a TN (twisted nematic) mode, a VA (vertically aligned) mode, an IPS (in plane switching) mode, a BP (blue phase) mode, a FFS (Fringe Field Switching) mode, and an ADS (Advanced Super Dimension Switch) mode, to name a few. An analog switching mode may be desirable in certain embodiments, in which gradual changes in the magnitude of voltage applied to the electrodes allows for variation in transmitted light intensity levels to achieve a gray scale effect. The liquid crystal device may also function in a binary switching mode with only two available light intensity transmission levels—bright/clear (high light transmission) and dark/opaque (low light transmission). One potential advantage for binary mode switching is the ability to function in a bistable fashion, such that electrical power is consumed only during switching between on and off states and is not consumed once these states are reached.

In some embodiments, dyes or other coloring agents, such as dichroic dyes, can be added to one or more of the liquid crystal layers to absorb light transmitted through the liquid crystal layer(s). Dichroic dyes typically absorb light more strongly along a direction parallel to the direction of a transition dipole moment in the dye molecule, which is typically the longer molecular axis of the dye molecule. Dye molecules oriented with their long axis perpendicular to the direction of light polarization will provide low light attenuation, whereas dye molecules oriented with their long axis parallel to the direction of light polarization will provide strong light attenuation.

Generally, liquid crystal devices function in a haze-free or low-haze fashion such that an observer can see through the liquid crystal device with little to no distortion. However, in certain instances, it may be desirable to provide the liquid crystal device with a “privacy” mode such that the image an observer can see through the liquid crystal device is darkened or diffused. Such a privacy mode can be achieved, e.g., by providing a light scattering effect to trap light within the liquid crystal layer such that the amount of light absorbed by the dye is increased.

Light scattering effects within the liquid crystal layer can be achieved in several different ways that promote or enhance the random alignment of liquid crystals. One or more chiral dopants may be added to the liquid crystal mixture to form highly twisted cholesteric liquid crystals (CLC), which may have a random alignment that provides light scattering effects, referred to herein as a focal conic texture. Random liquid crystal alignment can also be promoted or assisted by including polymer structures, such as polymer fibers, in the matrix of the liquid crystal layer, referred to herein as polymer stabilized cholesteric texture (PSCT). Random liquid crystal alignment can also be achieved using small droplets of nematic liquid crystal (without a chiral dopant) randomly dispersed in a solid polymer layer or a dense network of polymer fibers, or polymer walls, referred to herein as polymer dispersed liquid crystal (PDLC).

According to various embodiments, polymers may be dispersed in the matrix of the liquid crystal layer or on the interior surfaces of the glass and interstitial substrates. Such polymers may be formed by polymerization of monomers dissolved in the liquid crystal mixture. In certain embodiments, polymer protrusions or other polymerized structures may be formed on the interior surfaces of the outer substrates and/or interstitial substrates, such as in a normally clear liquid crystal device with homeotropic alignment layer(s), to define an azimuthal switching direction and to improve electro-optic switching speed.

As noted above, chiral dopants may be added to the liquid crystal mixture to achieve a twisted supramolecular structure of liquid crystal molecules, referred to herein as cholesteric liquid crystal (CLC). The amount of twist in the CLC is described by a helical pitch which represents the rotation angle of a local liquid crystal director by 360 degrees across the cell gap thickness. CLC twist can also be quantified by a ratio (d/p) of cell gap thickness (d) to CLC helical pitch (p). For liquid crystal applications, the amount of chiral dopant dissolved in the liquid crystal mixture can be controlled to achieve a desired amount of twist across a given cell gap distance. It is within the ability of one skilled in the art to select the appropriate dopant and its amount to achieve the desired twisted effect.

In various embodiments, the liquid crystal layers disclosed herein may have an amount of twist ranging from about 0° to about 25×360° (or d/p ranging from about 0 to about 25.0), for example, ranging from about 45° to about 1080° (d/p from about 0.125 to about 3), from about 90° to about 720° (d/p from about 0.25 to about 2), from about 180° to about 540° (d/p from about 0.5 to about 1.5), or from about 270° to about 360° (d/p from about 0.5 to about 1), including all ranges and subranges therebetween. As used herein, a liquid crystal mixture that does not include chiral dopants is referred to as a nematic liquid crystal (NLC). A liquid crystal that includes a chiral dopant and has a small pitch and a large twist refers to a CLC mixture wherein d/p is greater than 1. A liquid crystal that includes a chiral dopant and has a large pitch and a small twist refers to a CLC mixture wherein d/p is less than or equal to 1.

Windows

The methods disclosed herein can comprise one or more assembly steps for positioning the liquid crystal device relative to an additional glass substrate to form a liquid crystal window. Liquid crystal windows can be used in various architectural and transportation applications. For example, liquid crystal windows can be included in doors, space partitions, skylights, and windows for buildings, automobiles, and other transportation vehicles such as trains, planes, boats, and the like. A liquid crystal window may, in some embodiments, comprise an additional glass substrate, which is separated from the liquid crystal device by a gap.

The additional glass substrate can comprise any suitable glass material having any desired thickness, including those discussed above with respect to first and second substrates. The gap can be sealed and filled with air, an inert gas, or a mixture thereof, which may improve the thermal performance of the liquid crystal window. Suitable inert glasses include, but are not limited to, argon, krypton, xenon, and combinations thereof. Mixtures of inert gases or mixtures of one or more inert gases with air can also be used. Exemplary non-limiting inert gas mixtures include 90/10 or 95/5 argon/air, 95/5 krypton/air, or 22/66/12 argon/krypton/air mixtures. Other ratios of inert gases or inert gases and air can also be used depending on the desired thermal performance and/or end use of the liquid crystal window.

In various embodiments, the additional glass substrate is positioned as an interior pane, e.g., facing the interior of the building or vehicle, although the opposite orientation, with the additional glass substrate facing the exterior, is also possible. Liquid crystal window devices for use in architectural applications can have any desired dimension including, but not limited to 2′×4′ (width×height), 3′×5′, 5′×8′, 6′×8′, 7×10′, 7′×12′. Larger and smaller liquid crystal windows are also envisioned and are intended to fall within the scope of this disclosure. Liquid crystal windows can comprise one or more additional components such as a frame or other structural component, a power source, and/or a control device or system.

Processing Methods

Various methods for processing the components of the liquid crystal devices will now be discussed. The following general description is intended to provide an overview of certain steps that may be included in the claimed manufacturing methods, and various aspects will be more specifically discussed throughout the disclosure, these embodiments being interchangeable with one another within the context of the disclosure. According to various embodiments, the described processing steps may be performed in a clean room to avoid contamination of the processes components, such as in a class 10,000 cleanroom, a class 1,000 cleanroom, a class 100 cleanroom, or a class 10 cleanroom.

Substrate Cleaning

The methods disclosed herein can, in various embodiments, include at least one step for cleaning one or more of the substrates in the liquid crystal device. Cleaning steps can be performed prior to assembly of the liquid crystal device, after assembly, and/or in between any step included in the disclosed methods. For example, substrate cleaning may be performed prior to or during production of the substrate assembly, e.g., prior to application of at least one of an alignment layer and/or electrode layer, or after application of either of these layers.

Cleaning may be performed to remove contamination from one or more surfaces of the substrates, such as solid particle contamination and/or organic chemical contamination. In some embodiments, substrate cleaning may comprise a wet cleaning, e.g., rinsing one or more surfaces of the substrate with a solution comprising a surfactant or detergent, rinsing with water, such as deionized water, to remove surfactant or detergent residues, rinsing with an alcohol to remove residual water from the surface, and/or drying to remove any residual liquids that may remain on the surface(s) from any of the previous steps. According to various embodiments, cleaning can be performed by immersing the substrate in an ultrasonic bath for a time period ranging, for example, from about 1 minute to about 30 minutes, such as from about 2 minutes to about 20 minutes, from about 3 minutes to about 15 minutes, or from about 5 minutes to about 10 minutes, including all ranges and subranges therebetween. The ultrasonic bath can comprise water or a solution of water and surfactant, which can be at room temperature or higher, such as ranging from about 20° C. to about 80° C., from about 25° C. to about 70° C., from about 30° C. to about 60° C., or from about 40° C. to about 50° C., including all ranges and subranges therebetween. Drying can be performed at room temperature or in a chamber at an elevated temperature, for instance, ranging from about 20° C. to about 150° C., from about 25° C. to about 120° C., from about 50° C. to about 100° C., from about 60° C. to about 90° C., or from about 70° C. to about 80° C., including all ranges and subranges therebetween.

According to various embodiments, ozone cleaning can also be used to remove residual organic contaminants from the substrate surface. Ozone cleaning may be advantageous prior to deposition of organic layers, such as alignment layers, to promote better wetting of the solution on the substrate surface. Exemplary ozone exposure times can range from about 1 minute to about 10 minutes, such as from about 2 minutes to about 9 minutes, from about 3 minutes to about 8 minutes, from about 4 minutes to about 7 minutes, or from about 5 minutes to about six minutes, including all ranges and subranges therebetween.

Electrode Layer Fabrication

The methods disclosed herein can, in certain embodiments, include at least one step for fabricating an electrode layer and/or depositing said layer on the surface of at least one substrate in the liquid crystal device. Electrode layers can be fabricated using any technique known in the art, such as vacuum sputtering, film lamination, or printing techniques, to name a few.

Vacuum sputtering can comprise, in certain embodiments, placing a substrate in a vacuum chamber or into a loading interlock of a vacuum chamber, closing the chamber door, pumping air out of the chamber to reach the desired vacuum level, e.g., about 10⁻⁶ Torr, and optionally introducing a supplementary gas, such as a mixture of argon and oxygen. The vacuum chamber can include a sputtering target made of the material chosen for the electrode layer, for instance, a transparent conductive oxide (TCO). Pulses of electromagnetic radiation, such as microwave wavelength radiation, can be generated and delivered close to the surface of the sputtering target, thereby producing a plasma containing molecules of the sputtering target material and the supplementary gas(es), if included. The substrate can be manipulated and/or positioned inside the chamber such that it is proximate to the sputtering target and the gas plasma generated at the surface. Molecules of the sputtering target material can thus settle on the surface of the substrate to form an electrode layer.

The thickness of the electrode layer can be controlled, for instance, by varying the velocity at which the substrate is translated relative to the sputtering target and/or by varying the sputtering time. According to some embodiments, sputtering cycles can be repeated more than once to accumulate a thicker film on the substrate surface. After sputtering is complete, the substrate and deposited electrode layer can, in some embodiments, be annealed by exposure to a heat source, which can be present within the vacuum chamber or external to the chamber. Without wishing to be bound by theory, it is believed that annealing may improve at least one of the visible light transmission, sheet resistance, and mechanical properties of the coated electrode layer by, for example, changing the microstructure of the sputtered film from an amorphous state to a polycrystalline state.

Electrode Layer Patterning

The methods disclosed herein can, in non-limiting embodiments, include at least one step for patterning an electrode layer on the surface of a substrate in the liquid crystal device. Electrode layers can be patterned using any technique known in the art, such as photolithography or laser patterning, to name a few.

Laser patterning can be performed, for example, by locally damaging, ablating, or burning the electrode layer using a focused high energy laser beam operating, for instance, at a wavelength of about 532 nm, about 1064 nm, or about 10604 nm. Laser patterning may be advantageous for forming small scale or intricate patterns on the electrode layer, such as fiducial marks, contact pads for wire bonding, or conductive traces for electrical connections between transparent conductive layers on different substrates.

Photolithography patterning can be carried out, in some embodiments, by coating the electrode surface with a thin layer of photoresist, e.g., having a thickness ranging from about 0.5 microns to about 5 microns, such as from about 1 micron to about 4 microns, or from about 2 microns to about 3 microns, including all ranges and subranges therebetween. A photoresist solution may be applied and dried at an elevated temperature, such as from about 60° C. to about 120° C., from about 70° C. to about 100° C., or from about 80° C. to about 90° C., including all ranges and subranges therebetween, and for a time period ranging from about 15 seconds to about 2 minutes, such as from about 20 seconds to about 90 seconds, from about 30 seconds to about 75 seconds, or from about 45 seconds to about 1 minute, including all ranges and subranges therebetween. The dried photoresist film may then be exposed to UV light through a shadow mask defining the desired pattern. A developer solution can then be applied to preferentially remove the portions of photoresist layer that were exposed to UV light. The developed substrate may be subsequently rinsed, e.g., with deionized water, to remove any residual developer solution and may also be optionally dried, e.g., at room temperature or elevated temperature. The developed substrate may then be placed into an etching solution, such as an acid solution, to remove the portions of electrode layer that are not protected by the photoresist. The etching solution can be chosen, for example, from hydrochloric acid (HCl), nitric acid (HNO₃), and mixtures thereof, which can be optionally diluted with water. The concentration of the etching solution and etching time can be varied based on the material to be etched and the desired effect. After etching, the substrate may again be rinsed, e.g., with deionized water, to remove any residual etching solution.

Photolithography techniques may be useful for patterning pixels or common electrodes located in areas of the liquid crystal device that may be exposed to the end user, such as through an opening in a frame around the device or window. Photolithography can also be used to form contact pads for wire bonding located at recessed edges of the substrates, traces for electrical connection of the electrode layers on different substrates via conductive sealant or other conductors, and fiducial marks for alignment during cell assembly. The fiducial marks may, for example, be located at the edges or corners of the substrate.

Alignment Layer Fabrication

The methods disclosed herein can, in certain embodiments, include at least one step for fabricating an alignment layer and/or depositing said layer on the surface of a substrate or electrode layer in the liquid crystal device. Alignment layers can be deposited using any technique known in the art, such as spin coating, ink jet printing, or thermal evaporation techniques. In some embodiments, organic alignment layers may be deposited by spin coating or printing techniques and inorganic alignment layers can be deposited using thermal evaporation techniques.

In certain embodiments, the surface of a substrate or electrode layer can be coated with a solution of alignment layer material, such as polymers, e.g., polyimides. After coating, the substrate can be “soft-baked” to evaporate solvent by exposure to a first elevated temperature, such as ranging from about 60° C. to about 110° C., from about 70° C. to about 100° C., or from about 80° C. to about 90° C., including all ranges and subranges therebetween, for a time period ranging from about 1 minute to about 5 minutes, or from about 2 minutes to about 3 minutes, including all ranges and subranges therebetween. Subsequently, the substrate can be “hard-baked” by exposure to a second elevated temperature, such as ranging from about 150° C. to about 300° C., from about 180° C. to about 250° C., or from about 200° C. to about 220° C., including all ranges and subranges therebetween, for a time period ranging from about 15 minutes to about 2 hours, such as from about 20 minutes to about 90 minutes, from about 30 minutes to about 75 minutes, or from about 45 minutes to about 1 hour, including all ranges and subranges therebetween. Temperature ramp rates between the first “soft-bake” temperature and the second “hard-bake” temperature can vary and, in some embodiments, may range from about 0.1° C./min to about 300° C./min, such as from about 1° C./min to about 200° C./min, from about 5° C./min to about 100° C./min, or from about 20° C./min to about 50° C./min, including all ranges and subranges therebetween. Similar ramp rates may be used to cool the substrate, e.g., from the “hard-bake” temperature back to room temperature.

Alignment Layer Treatment

The methods disclosed herein can, in various embodiments, include at least one step for treating an alignment layer to generate surface or layer anisotropy. According to certain embodiments, the alignment layers can be rubbed to define an azimuthal orientation of liquid crystal molecules on the surface of a substrate. Such an orientation is referred to herein as “rubbing direction.” Alignment layers used to promote vertical or homeotropic liquid crystal orientation can be rubbed to create a pretilt angle other than 90° with respect to the plane of the substrate, such as 89°.

Rubbing can be performed, for instance, by sliding a synthetic cloth such as velvet over the top surface of the alignment layer. The cloth can be placed on a flat holder or on a rotating cylindrical holder. The duration and amount of force applied to the surface of the alignment layer can be adjusted as desired to achieve the desired anisotropy, while also avoiding the creation of scratches or other mechanical damage to the alignment layer.

Spacer Application

The methods disclosed herein can, in various embodiments, include at least one step for creating a cell gap to define at least one liquid crystal layer in the liquid crystal device. Cell gap thickness can be defined, for instance, by the size of spacers placed between two substrates confining the liquid crystal layer.

Exemplary spacers include photo spacers, which can be fabricated in a desired position using a photolithography process. Spacers can also comprise microparticles having a defined shape and size, which can be distributed on a substrate in random order and at a desired density per unit area. Microparticle spacers can, in some embodiments, have a spherical or cylindrical shape and may comprise, for example, an inorganic material such as silica or glass. According to various embodiments, the spacers can be transparent or colorless. In alternative embodiments, the spacers can be colored to blend with the appearance of the liquid crystal material in a desired optical state.

Liquid Crystal Layer Sealing

The methods disclosed herein can, in various embodiments, include at least one step for sealing a cell gap filled with liquid crystal material. An optically curable or thermally curable adhesive can be applied around all edges of at least one of the substrates confining the liquid crystal layer, e.g., using a fluid dispensing system. After dispensing the adhesive on the substrate, it may be subsequently activated and cured, for example, by exposure to light and/or heat. In certain embodiments, the adhesive layer is protected from exposure to light and/or heat until the liquid crystal layer is assembled and ready for curing.

Optically curable adhesives include, for example, liquid photopolymer products that solidify upon exposure to ultraviolet light, such as NOA65 or NOA68 from Norland Products, Inc. Thermally curable adhesives can be chosen from one-part or two-part epoxies. Non-limiting exemplary epoxies can be chosen from MasterSil 800 or EP17HT-LO from Master Bond, Inc. In various embodiments, the thermally curable adhesive can have a temperature resistance of greater than 200° C., such as greater than 300°, greater than 400°, or greater than 500°, including all ranges and subranges therebetween.

According to some embodiments, the adhesive may include spacer beads to provide a desired cell gap thickness. The adhesive may also or alternatively include conductive particles, such as silver, gold, or nickel particles, which allow for the creation of an electrical connection between two electrode layers located on either side of the liquid crystal layer.

Liquid Crystal Layer Filling

The methods disclosed herein can, in various embodiments, include at least one step for filling a cell gap with liquid crystal material. Liquid crystal material can be dispensed onto a surface of substrate confining the liquid crystal layer, e.g., using a one-drop filling (ODF) technique. ODF filling can be performed in a vacuum by dispensing small droplets of liquid crystal material across the surface of the substrate, which may be surrounded by a closed loop of adhesive material defining the edge seal. In various embodiments, the liquid crystal material is deposited in an amount sufficient to fill the cell gap to avoid or substantially avoid defects such as air bubbles.

Liquid Crystal Layer Assembly

The methods disclosed herein can, in various embodiments, include at least one step for assembling a liquid crystal cell or layer. Two substrates are placed in a vacuum chamber, one substrate comprising dispensed adhesive and dispensed liquid crystal material. The two substrates can be held by two vacuum chucks incorporated into upper and lower positioning tables. The substrate surfaces defining the interior of the liquid crystal cell are positioned facing each other and at least one is manipulated mechanically to align the substrates, e.g., using fiducial marks. Fiducial marks can be located at the edges and/or corners of the substrate to enable high precision substrate positioning. Substrate alignment can include lateral translation and/or rotation. Machine vision cameras can be used to provide high precision feedback for quantifying the accuracy of substrate alignment. Upon alignment, the substrates are brought into direct contact to form the liquid crystal cell. At least one of the substrates can be translated vertically to achieve direct contact between the substrates. Upon contact, the edge seal can be cured using any technique suitable for the chosen adhesive, i.e., by exposure to UV light or heat. The assembled liquid crystal cell can then be removed from the vacuum chamber for use in the manufacture of the remainder of the liquid crystal device.

Liquid Crystal Layer Curing

The methods disclosed herein may, in certain embodiments, include at least one step for curing a liquid crystal layer. Certain liquid crystal mixtures or liquid crystal modes may benefit from UV curing, such as polymer stabilized vertical alignment (PSVA) liquid crystal, which contain polymerizable reactive monomer additives. UV curing can be performed by powering on the assembled liquid crystal cell and allowing any topological liquid crystal defects to relax, thereby forming a substantially uniform orientation of liquid crystals across the cell. While still powered on, the liquid crystal layer can be exposed to UV light at intensities sufficient to polymerize and surface-localize monomer additives dissolved in the liquid crystal mixture.

Wire Bonding

The methods disclosed herein can, in various embodiments, include at least one step for wire bonding electrode layers within a liquid crystal device. After singulation of the liquid crystal device, which is discussed in more detail below, the recessed edges of the substrates can be cleaned or treated, e.g., to remove the alignment layer and provide electrical connection between the electrode layers and/or electrode contact pads. Removal of the alignment layer from the edges of the substrate can be carried out, in some embodiments, using a plasma cleaning technique. Exposed sections of each electrode layer can be electrically linked to one or more power sources, which can be used to supply power to the liquid crystal cell during operation of the device. In certain embodiments, the electrode layers may also be electrically linked to each other, or shorted. Electrical linkages can be formed using metalized or other flexible connectors.

Assembly Methods

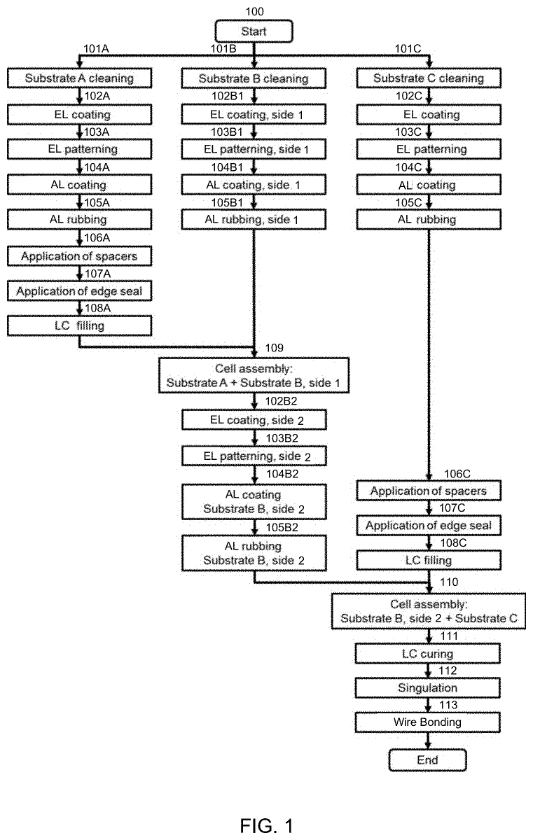

Embodiments of the disclosure will now be discussed with reference to FIGS. 1-3, which illustrate various non-limiting process flow diagrams for assembly of the liquid crystal device. The following general description and figures are intended to provide an overview of the claimed methods, and various aspects will be more specifically discussed throughout the disclosure with reference to the non-limiting depicted embodiments, these embodiments being interchangeable with one another within the context of the disclosure.

Process Flow I

FIG. 1 illustrates an exemplary process flow diagram for assembling a liquid crystal device according to embodiments of the disclosure. In instances where the same step is performed on different substrates, such as, e.g., steps 101A-C, 102A-C, 103A-C, etc., the substrates A-C can be processed in parallel or sequentially in any order as desired by the operator.

Process 100 can begin with optional substrate cleaning steps 101A-C, in which one or more surfaces of the first, second, and third substrates (substrates A, C, B, respectively) are cleaned according to one of the methods disclosed herein or any other suitable cleaning method. In steps 102A, 10261, and 102C, an electrode layer EL is deposited on a surface of substrates A, B (side 1), and C. Depending on the electrical configuration of the liquid crystal device, one or more of these steps may be optional. For instance, step 102B1 may not be carried out if the interstitial substrate (B) assembly does not comprise electrode layers. Similarly, if the outer substrate (A, C) assembly does not comprise electrode layers, then steps 102A, 102C may not be carried out. In steps 103A, 10361, and 103C, the deposited electrode layers may be processed to create one or more desired pattern(s). Alternatively, one or more of steps 103A, 10361, and 103C may be skipped if no electrode pattern is desired, depending on the selected liquid crystal cell design and/or liquid crystal electro-optic mode. Of course, if the preceding step of electrode layer deposition is not carried out, then the corresponding patterning step would also not be carried out.

In steps 104A, 10461, and 104C, an alignment layer AL is deposited on a surface of substrates A, B (side 1), C, or on the surface of the electrode layer EL, if present. For instance, in the case of first substrate A, an electrode layer may be deposited (102A) on a first surface of the substrate and optionally patterned (103A), followed by deposition of an alignment layer AL in step 104A, the alignment layer being deposited on the electrode layer EL. Alternatively, if steps 102A, 103A are skipped, the alignment layer AL can be deposited directly on a surface of the substrate in step 104A. Application of alignment layers to substrates B and C can be similarly arranged depending on the presence or absence of an electrode layer EL. It should also be noted that steps 104A, 10461, and 104C are also optional, as it is not always necessary to have an alignment layer in each substrate assembly. For example, certain liquid crystal modes may not require an alignment layer, such as privacy modes with nematic, cholesteric or smectic liquid crystal materials or self-aligning vertical alignment (SAVA) liquid crystal modes. Alternatively, a single alignment layer may suffice for aligning a liquid crystal layer, such that only one of the substrates defining each liquid crystal cell comprises an alignment layer. For instance, if the first substrate (A) assembly comprises an alignment layer, then it may not be necessary for the third substrate (B) assembly to comprise an alignment layer, or vice versa. Similarly, if the second substrate (C) assembly comprises an alignment layer, then it may not be necessary for the third substrate (B) assembly to comprise an alignment layer, or vice versa.

In steps 105A, 105B1, and 105C, the alignment layer AL is rubbed or otherwise treated to create the desired anisotropy. Of course, one or more of these steps may be skipped if, for instance, one or more of the preceding steps 104A, 104B1, and 104C of applying the alignment layer(s) is not carried out. Furthermore, one or more of steps 105A, 105B1, and 105C may be skipped depending on the liquid crystal mode. For example, polymer structured vertical alignment (PSVA) liquid crystal may not require surface treatment or rubbing of the alignment layer AL.

In step 106A, spacers are applied to the treated surface of substrate A, e.g., the surface comprising the electrode and/or alignment layer(s), if desired, to help define the dimensions of the liquid crystal layer or half-cell formed by substrates A and B. In step 107A, the edge seal is applied to the treated surface of substrate A to define the liquid crystal cell perimeter. Liquid crystal material is then filled into the space defined by the spacers and/or edge seal in step 108A and the liquid crystal half-cell may then be assembled in step 109 as outlined below. Alternatively, it is also possible to apply the spacers, edge seal, and liquid crystal material to side 1 of substrate B, instead of substrate A, and to proceed with the liquid crystal half-cell assembly in step 109. Still another alternative is to apply the edge seal and liquid crystal material to substrate A and to apply the spacers to side 1 of substrate B, or vice versa, and to proceed with the liquid crystal half-cell assembly in step 109.

Similarly, in step 106C, spacers are applied to the treated surface of substrate C, e.g., the surface comprising the electrode and/or alignment layer(s), if desired, to help define the dimensions of the liquid crystal half-cell formed by substrates C and B. In step 107C, the edge seal is applied to the treated surface of substrate C to define the liquid crystal cell perimeter. Liquid crystal material is then filled into the space defined by the spacers and/or edge seal in step 108C and the liquid crystal half-cell may then be assembled in step 110 as outlined below. Alternatively, it is also possible to apply the spacers, edge seal, and liquid crystal material to side 2 of substrate B, instead of substrate C, and to proceed with the liquid crystal half-cell assembly in step 110. Still another alternative is to apply the edge seal and liquid crystal material to substrate C and to apply the spacers to side 2 of substrate B, or vice versa, and to proceed with the liquid crystal half-cell assembly in step 109.

In the process flow depicted in FIG. 1, the liquid crystal device undergoes single-sided processing, in which side 1 of substrate B is coated with an electrode layer EL (10261), patterned (10361), coated with an alignment layer AL (10461), and rubbed (10561), these steps each being optional depending on the desired end product. The process flow then proceeds to assembly of a half-cell with substrates A and B in step 109, in which the treated side of substrate A, e.g., the surface comprising the liquid crystal material, edge seal, and/or spacers, is positioned to face and is brought into contact with side 1 of substrate B. The edge seal applied in step 107A can also be cured in step 109 to seal the liquid crystal half-cell (A+B) before proceeding with the remainder of processing.

After the assembly step 109, side 2 of substrate B can be processed similarly to side 1. Side 2 of substrate B can, for example, be coated with an electrode layer EL (10262), patterned (10362), coated with an alignment layer AL (10462), and rubbed (10562), these steps each being optional depending on the desired end product. The process flow then proceeds to assembly of the other half-cell with substrates C and B in step 110, in which the treated side of substrate C, e.g., the surface comprising the liquid crystal material, edge seal, and/or spacers, is positioned to face and is brought into contact with side 2 of substrate B. The edge seal applied in step 107C can also be cured in step 110 to seal the liquid crystal half-cell (B+C) before proceeding with the remainder of processing.

After the half-cells (A+B) and (B+C) are assembled, the liquid crystal material within both cells can be cured in step 111. This step can be optional depending on the type of liquid crystal material selected. For example, curing can be carried out for liquid crystal materials comprising polymerizable additives, such as PSVA liquid crystal, or to create privacy modes. Other liquid crystal materials may not require a curing step, in which case the process flow can proceed from assembly 110 straight to singulation 112. Singulation in step 112 can be carried out to separate individual liquid crystal devices from, e.g., a larger template, as discussed in more detail below. Finally, in step 113, wire bonding may be carried out to electrically connect the electrode layer(s) within the device to power sources and, in some embodiments, to each other, depending on the desired operation of the liquid crystal device.

Process Flow II

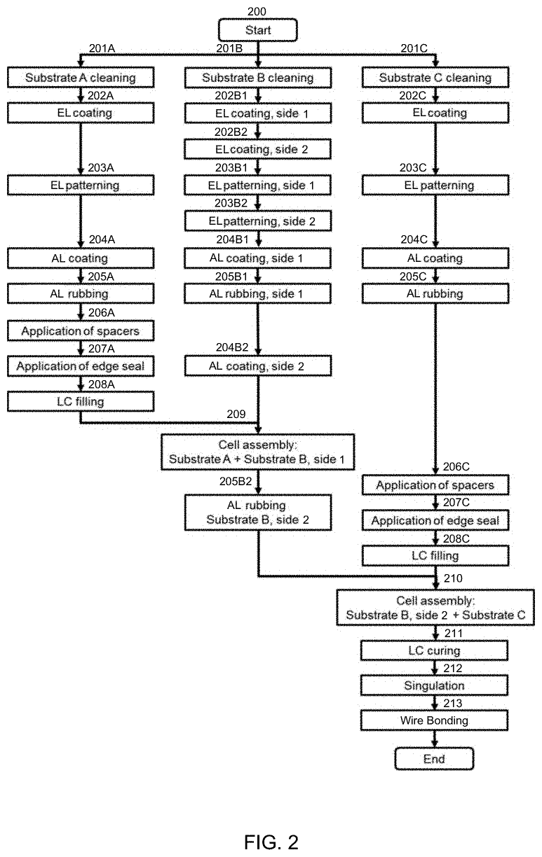

FIG. 2 illustrates an exemplary process flow diagram for assembling a liquid crystal device according to additional embodiments of the disclosure. As in FIG. 1, in instances where the same step is performed on different substrates, such as, e.g., steps 201A-C, 202A-C, 203A-C, etc., the substrates A-C can be processed in parallel or sequentially in any order as desired by the operator.

The process flow depicted in FIG. 2 differs from that of FIG. 1 in that the liquid crystal device undergoes double-sided processing, in which sides 1 and 2 of the third substrate (substrate B) are both coated with an electrode layer EL, patterned, and coated with an alignment layer AL prior to the half-cell assembly steps 109 and 110, which are discussed in more detail below. Double-sided processing of the third substrate can include simultaneous or sequential processing of sides 1 and 2 of substrate B. Double-sided processing on both sides of a substrate can be carried out provided that mechanical contact when holding or manipulating the substrate occurs outside of the active liquid crystal window areas that will be exposed to the end user.

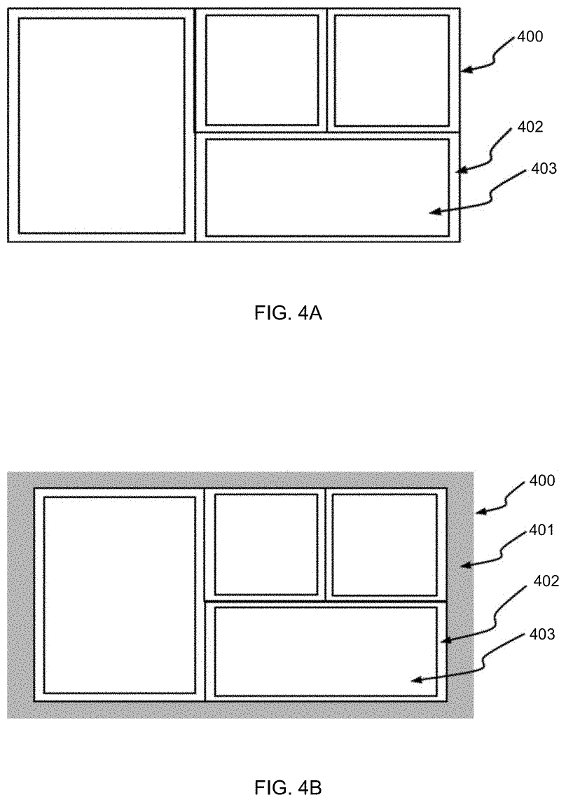

Referring to FIG. 4A, a motherboard glass 400 is illustrated comprising four different sections that can be singulated to form separate devices after processing. An exemplary active portion of the liquid crystal device is labeled as 403. This portion of the motherboard glass 400 should not be mechanically contacted during double-sided processing. However, portions 402 of the motherboard glass that will be covered by a frame in a liquid crystal window device can be mechanically contacted and used to hold and/or manipulate the substrate during processing. These portions 402 can include recessed parts of the substrate intended for wire bonding, or parts that can be used for mechanical positioning of the assembled liquid crystal device in a window device, or parts of the substrate that will be covered by the edge seal of the liquid crystal cell. Alternatively, referring to FIG. 4B, the motherboard glass can include a sacrificial portion 401, that will be discarded after singulation and will not become part of the end product. These sacrificial portions 401 can also be mechanically contacted and used to hold and/or manipulate the substrate during processing.

By way of non-limiting example, double-sided processing can include placing a first side of the substrate, e.g., side 1 of substrate B, on a holding frame or on a vacuum chuck and stabilizing it with its own weight or one or more vacuum suction cups. The second side of the substrate, e.g., side 2 of substrate B, can be processed in this configuration and then the substrate can be flipped over for processing of the first side. Alternatively, the substrate can be mechanically stabilized and/or manipulated such that both sides of the substrate can be processed simultaneously.

Referring again to FIG. 2, process 200 can begin with optional substrate cleaning steps 201A-C, in which one or more surfaces of the first, second, and third substrates (substrates A, C, B, respectively) are cleaned according to one of the methods disclosed herein or any other suitable cleaning method. In steps 202A and 202C, an electrode layer EL is deposited on a surface of substrates A and C. Similarly, in steps 202B1 and 202B2, which can be carried out simultaneously or sequentially, an electrode layer EL is deposited on sides 1 and 2 of substrate B, respectively. Depending on the electrical configuration of the liquid crystal device, one or more of these steps may be optional. For instance, steps 202B1 and 202B2 may not be carried out if the interstitial substrate (B) assembly does not comprise electrode layers. Similarly, if the outer substrate (A, C) assembly does not comprise electrode layers, then steps 202A, 202C may not be carried out. In steps 203A, 203B1, 203B2, and 203C, the deposited electrode layers may be processed to create one or more desired pattern(s). Double-sided processing of substrate B in steps 203B1 and 203B2 may be carried out sequentially or simultaneously. Alternatively, one or more of steps 203A, 203B1, 203B2, and 203C may be skipped if no electrode pattern is desired, depending on the selected liquid crystal cell design and/or liquid crystal electro-optic mode. Of course, if the preceding step of electrode layer deposition is not carried out, then the corresponding patterning step would also not be carried out.

In steps 204A, 204B1, and 204C, an alignment layer AL is deposited on a surface of substrates A, B (side 1) and C, or on the surface of the electrode layer EL, if present. For instance, in the case of first substrate A, an electrode layer may be deposited (202A) on a first surface of the substrate and optionally patterned (203A), followed by deposition of an alignment layer AL in step 204A, the alignment layer being deposited on the electrode layer EL. Alternatively, if steps 202A, 203A are skipped, the alignment layer AL can be deposited directly on a surface of the substrate in step 204A. Application of alignment layers to substrates B and C can be similarly arranged depending on the presence or absence of an electrode layer EL. It should also be noted that steps 204A, 204B1, and 204C are also optional, as it is not always necessary to have an alignment layer in each substrate assembly. Alternatively, a single alignment layer may suffice for aligning a liquid crystal layer, such that only one of the substrates defining each liquid crystal cell comprises an alignment layer.

In steps 205A, 205B1, and 205C, the alignment layer AL is rubbed or otherwise treated to create the desired anisotropy. Of course, one or more of these steps may be skipped if, for instance, one or more of the preceding steps 204A, 204B1, and 204C of applying the alignment layer(s) is not carried out. Furthermore, one or more of steps 205A, 205B1, and 205C may be skipped depending on the liquid crystal mode.

In step 206A, spacers are applied to the treated surface of substrate A, e.g., the surface comprising the electrode and/or alignment layer(s), if desired, to help define the dimensions of the liquid crystal half-cell formed by substrates A and B. In step 207A, the edge seal is applied to the treated surface of substrate A to define the liquid crystal cell perimeter. Liquid crystal material is then filled into the space defined by the spacers and edge seal in step 208A and the liquid crystal half-cell may then be assembled in step 209 as outlined below. Alternatively, it is also possible to apply the spacers, edge seal, and liquid crystal material to side 1 of substrate B, instead of substrate A, and to proceed with the liquid crystal half-cell assembly in step 209.

Similarly, in step 206C, spacers are applied to the treated surface of substrate C, e.g., the surface comprising the electrode and/or alignment layer(s), if desired, to help define the dimensions of the liquid crystal half-cell formed by substrates C and B. In step 207C, the edge seal is applied to the treated surface of substrate C to define the liquid crystal cell perimeter. Liquid crystal material is then filled into the space defined by the spacers and edge seal in step 208C and the liquid crystal half-cell may then be assembled in step 210 as outlined below. Alternatively, it is also possible to apply the spacers, edge seal, and liquid crystal material to side 2 of substrate B, instead of substrate C, and to proceed with the liquid crystal half-cell assembly in step 210.

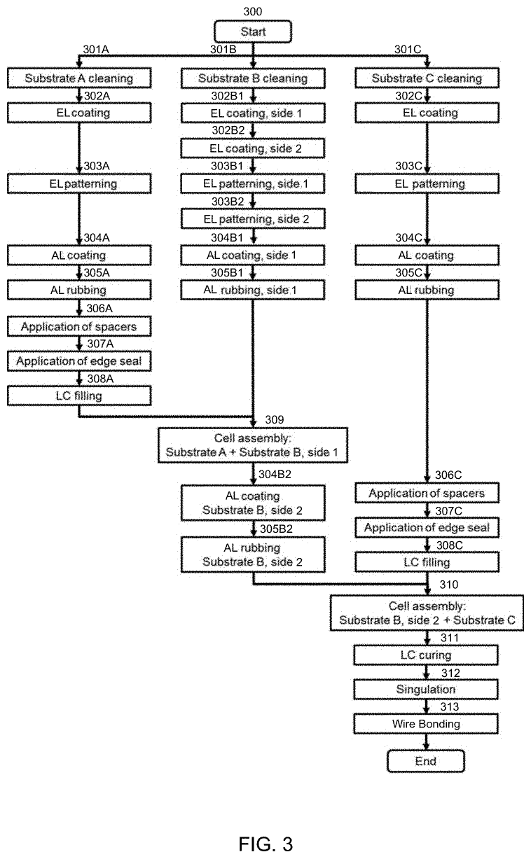

In the process flow depicted in FIG. 2, an alignment layer AL is applied to side 2 of substrate B in step 204B2 before the half-cell assembly step 209, and the alignment layer AL is rubbed in step 205B2 after the half-cell (A+B) is assembled. Of course, both of these steps are optional and may not be carried out at all. However, it is also possible for steps 204B2 and 205B2 to both be carried out before or after half-cell assembly step 209. For example, as shown in FIG. 3, discussed in more detail below, steps 304B2 and 305B2 are carried out after half-cell assembly step 309. In the process flow shown in FIG. 2, steps 204B1 and 204B2 are performed sequentially, but they can also be performed simultaneously. Similarly, steps 205B1 and 205B2 can be performed sequentially or simultaneously. It should be noted, however, that the alignment layer may be potentially scratched or otherwise damaged during handling and processing, which can cause optical defects that are visible to the end user. As such, in this process flow, all substrates and, particularly, substrate B should be handled with care to ensure that the alignment layers AL on both sides remain in good condition until assembled into the liquid crystal cell.

In step 209, assembly of a half-cell with substrates A and B is carried out, during which the treated side of substrate A, e.g., the surface comprising the liquid crystal material, edge seal, and/or spacers, is positioned to face and is brought into contact with side 1 of substrate B. The edge seal applied in step 207A can also be cured in step 209 to seal the liquid crystal half-cell (A+B) before proceeding with the remainder of processing. After the half-cell assembly step 209, the other half-cell with substrates C and B can be assembled in step 210. The treated side of substrate C, e.g., the surface comprising the liquid crystal material, edge seal, and/or spacers, is positioned to face and is brought into contact with side 2 of substrate B. The edge seal applied in step 207C can also be cured in step 210 to seal the liquid crystal half-cell (B+C) before proceeding with the remainder of processing.

After the half-cells (A+B) and (B+C) are assembled, the liquid crystal material within both cells can be cured in step 211. This step can be optional depending on the type of liquid crystal material selected. Certain liquid crystal materials may not require a curing step, in which case the process flow can proceed from assembly 209, 210 straight to singulation 212. Finally, in step 213, wire bonding may be carried out to electrically connect the electrode layer(s) within the device to power sources and, in some embodiments, to each other, depending on the desired operation of the liquid crystal device.

Process Flow III

FIG. 3 illustrates an exemplary process flow diagram for assembling a liquid crystal device according to further embodiments of the disclosure. As in FIGS. 1-2, in instances where the same step is performed on different substrates, such as, e.g., steps 301A-C, 302A-C, 303A-C, etc., the substrates A-C can be processed in parallel or sequentially in any order as desired by the operator. The process flow depicted in FIG. 3 also includes double-sided processing of substrate B, but differs from that of FIG. 2 in that the alignment layer AL is applied to side 2 (30462) and rubbed (30562) after the half-cell assembly step 109.

Process 300 can begin with optional substrate cleaning steps 301A-C, in which one or more surfaces of the first, second, and third substrates (substrates A, C, B, respectively) are cleaned according to one of the methods disclosed herein or any other suitable cleaning method. In steps 302A and 302C, an electrode layer EL is deposited on a surface of substrates A and C. Similarly, in steps 302B1 and 302B2, which can be carried out simultaneously or sequentially, an electrode layer EL is deposited on sides 1 and 2 of substrate B, respectively. Depending on the electrical configuration of the liquid crystal device, one or more of these steps may be optional. For instance, steps 302B1 and 302B2 may not be carried out if the interstitial substrate (B) assembly does not comprise electrode layers. Similarly, if the outer substrate (A, C) assembly does not comprise electrode layers, then steps 302A, 302C may not be carried out. In steps 303A, 303B1, 303B2, and 303C, the deposited electrode layers may be processed to create one or more desired pattern(s). Double-sided processing of substrate B in steps 303B1 and 303B2 may be carried out sequentially or simultaneously. One or more of steps 303A, 303B1, 303B2, and 303C may be skipped if no electrode pattern is desired, depending on the selected liquid crystal cell design and/or liquid crystal electro-optic mode. Of course, if the preceding step of electrode layer deposition is not carried out, then the corresponding patterning step would also not be carried out.

In steps 304A, 304B1, and 304C, an alignment layer AL is deposited on a surface of substrates A, B (side 1) and C, or on the surface of the electrode layer EL, if present. For instance, in the case of first substrate A, an electrode layer may be deposited (302A) on a first surface of the substrate and optionally patterned (303A), followed by deposition of an alignment layer AL in step 304A, the alignment layer being deposited on the electrode layer EL. Alternatively, if steps 302A, 303A are skipped, the alignment layer AL can be deposited directly on a surface of the substrate in step 304A. Application of alignment layers to substrates B and C can be similarly arranged depending on the presence or absence of an electrode layer EL. It should also be noted that steps 304A, 304B1, and 304C are also optional, as it is not always necessary to have an alignment layer in each substrate assembly. Alternatively, a single alignment layer may suffice for aligning a liquid crystal layer, such that only one of the substrates defining each liquid crystal cell comprises an alignment layer.

In steps 305A, 305B1, and 305C, the alignment layer AL is rubbed or otherwise treated to create the desired surface anisotropy. Of course, one or more of these steps may be skipped if, for instance, one or more of the preceding steps 304A, 304B1, and 304C of applying the alignment layer(s) is not carried out. Furthermore, one or more of steps 305A, 305B1, and 305C may be skipped depending on the liquid crystal mode.

In step 306A, spacers are applied to the treated surface of substrate A, e.g., the surface comprising the electrode and/or alignment layer(s), if desired, to help define the dimensions of the liquid crystal half-cell formed by substrates A and B. In step 307A, the edge seal is applied to the treated surface of substrate A to define the liquid crystal cell perimeter. Liquid crystal material is then filled into the space defined by the spacers and edge seal in step 308A and the liquid crystal half-cell may then be assembled in step 309 as outlined below. Alternatively, it is also possible to apply the spacers, edge seal, and liquid crystal material to side 1 of substrate B, instead of substrate A, and to proceed with the liquid crystal half-cell assembly in step 309.

Similarly, in step 306C, spacers are applied to the treated surface of substrate C, e.g., the surface comprising the electrode and/or alignment layer(s), if desired, to help define the dimensions of the liquid crystal half-cell formed by substrates C and B. In step 307C, the edge seal is applied to the treated surface of substrate C to define the liquid crystal cell perimeter. Liquid crystal material is then filled into the space defined by the spacers and edge seal in step 308C and the liquid crystal half-cell may then be assembled in step 310 as outlined below. Alternatively, it is also possible to apply the spacers, edge seal, and liquid crystal material to side 2 of substrate B, instead of substrate C, and to proceed with the liquid crystal half-cell assembly in step 310.

In the process flow depicted in FIG. 3, an alignment layer AL is applied to side 2 of substrate B in step 304B2 and rubbed in step 305B2 after the half-cell assembly step 309. Of course, both of these steps are optional and may not be carried out at all. In step 309, assembly of a half-cell with substrates A and B is carried out, during which the treated side of substrate A, e.g., the surface comprising the liquid crystal material, edge seal, and/or spacers, is positioned to face and is brought into contact with side 1 of substrate B. The edge seal applied in step 307A can also be cured in step 309 to seal the liquid crystal half-cell (A+B) before proceeding with the remainder of processing. After the half-cell assembly step 309, the other half-cell with substrates C and B can be assembled in step 310. The treated side of substrate C, e.g., the surface comprising the liquid crystal material, edge seal, and/or spacers, is positioned to face and is brought into contact with side 2 of substrate B. The edge seal applied in step 307C can also be cured in step 310 to seal the liquid crystal half-cell (B+C) before proceeding with the remainder of processing.

After the half-cells (A+B) and (B+C) are assembled, the liquid crystal material within both cells can be cured in step 311. This step can be optional depending on the type of liquid crystal material selected. Certain liquid crystal materials may not require a curing step, in which case the process flow can proceed from assembly 309, 310 straight to singulation 312. Finally, in step 313, wire bonding may be carried out to electrically connect the electrode layer(s) within the device to power sources and, in some embodiments, to each other, depending on the desired operation of the liquid crystal device.

Singulation Methods

The methods disclosed herein can include processing one or more motherboard glass substrates comprising multiple portions that can be subsequently singulated to form separate liquid crystal devices, e.g., as shown in FIGS. 4A-B. Multi-substrate processing using a motherboard glass assembly can, in some embodiments, decrease manufacturing cost, time, and/or complexity. However, a multi-layer device, e.g., including three or more substrates, cannot be singulated from the motherboard glass assembly using traditional scribe and break techniques because the interstitial glass layer(s) cannot be contacted by a scribing wheel. As such, the methods disclosed herein may employ a multi-scribing singulation process to separate individual liquid crystal devices from a motherboard glass assembly. Cell singulation can also be carried out using laser cutting techniques capable of cutting through all three substrates simultaneously or sequentially. A combination of mechanical scribing and breaking and laser cutting may also be used depending on the dimensions of the substrates to be separated and the desired end product design. For example, laser cutting may be chosen for singulation of a device in which two or more substrates are designed to have flush edges. The singulation process may also be designed to create recessed cell edges that can expose at least one of the electrode layers on the interior surfaces of the substrates for wire bonding and electrical connection to an external power source. Laser cutting and/or scribing may be used depending on the dimensions of the recessed edge and whether it can accommodate a scribing wheel.

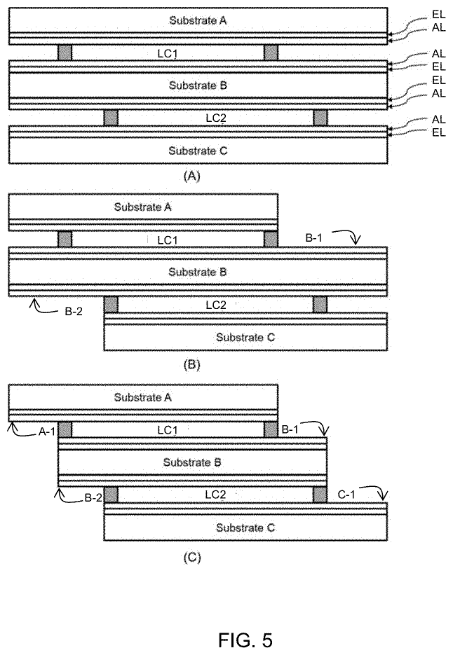

Embodiments of the disclosure will now be discussed with reference to FIGS. 5-9, which illustrate various singulation process examples. The following general description is intended to provide an overview of the claimed methods, and various aspects will be more specifically discussed throughout the disclosure with reference to the non-limiting depicted embodiments, these embodiments being interchangeable with one another within the context of the disclosure.

Generally speaking, the first step in the singulation process includes cutting all three substrates to separate them from the motherboard glass assembly. This first step can include the formation of one or more incisions or cuts. For example, several straight line cuts can be made to produce a triangular, square, rectangular, or polygonal shape. One or more curvilinear cuts can also be made to outline a circular, elliptical, or other free form shape. Combinations of straight and curvilinear cuts can also be used. The subsequent step(s) in the singulation process can be used to expose various interior surfaces of the substrates and the associated electrode layers, e.g., to produce locations for electrical connections or other structures. These steps can include cutting along the whole length of the liquid crystal device or only in specific locations of the device, such as corners of a polygonal shape or sections of an elliptical shape.

Singulation Process I

FIG. 5 illustrates an exemplary singulation process for a liquid crystal device comprising three glass substrates A-C. Liquid crystal layer LC1 is positioned between first substrate A and third substrate B, and liquid crystal layer LC2 is positioned between second substrates C and third substrate B. The liquid crystal layers LC1 and LC2 are offset from one another such that they overlap but their edges are not flush. Electrode layers EL and alignment layers AL are illustrated as present on both sides of the liquid crystal layers LC1 and LC2 but, as discussed above, these layers are optional and one or more of layers EL and AL may or may not be present depending on the desired liquid crystal device configuration.

The singulation process illustrated in FIG. 5 comprises three steps. In step (A), all three substrates are cut through to separate them from the motherboard glass assembly (not shown). In step (B), a portion of glass is removed from first and second substrates A and C, to form recessed edges exposing interior surfaces B-1, B-2 on opposing sides of third substrate B. In step (C), a portion of glass is removed from third substrate B to form a recessed edge exposing interior surfaces A-1, C-1 of first and second substrates A and C, respectively.

In the three-step process of FIG. 5, the first step includes cutting all of substrates A-C, the second step includes cutting substrates A and C only, and the third step includes cutting substrate B only. The first step (A) can be performed using a laser cutting technique to cut through all glass layers simultaneously or sequentially. The first step (A) can also be performed using a scribe and break technique on the outer substrates A and C and laser cutting on the interstitial substrate B. The second step (B) and/or third step (C) can be performed using laser cutting or mechanical scribe and break techniques.

While not illustrated, wire bonding can be used to connect any one or more of the electrode layers on substrates A-C to an external power source or, in some embodiments, one or more of the electrode layers may be electrically connected to each other or shorted. Wire bonding can be implemented at opposite ends of the liquid crystal cells LC1, LC2, e.g., to the right and left of the liquid crystal cells, or can be placed on adjacent edges of the liquid crystal cells, such as the left and top edges, the right and bottom edges, and so forth.

Singulation Process II

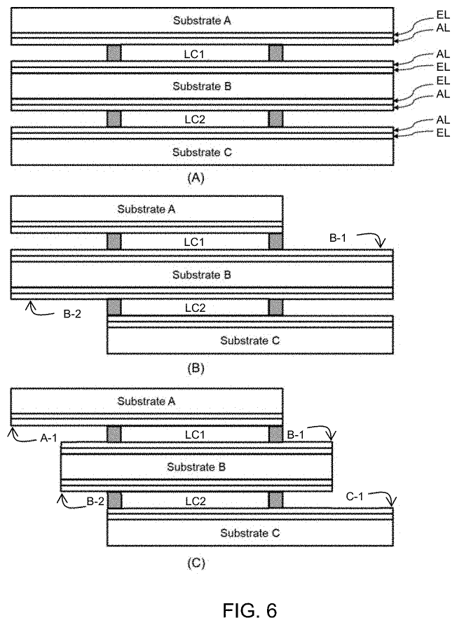

FIG. 6 illustrates an exemplary singulation process for a liquid crystal device comprising three glass substrates A-C. Liquid crystal layer LC1 is positioned between first substrate A and third substrate B, and liquid crystal layer LC2 is positioned between second substrate C and third substrate B. Unlike the design shown in FIG. 5, liquid crystal layers LC1 and LC2 are not offset and their edges are flush with each other. The singulation process illustrated in FIG. 6 can comprise the same three steps discussed above with respect to FIG. 5. While not illustrated, wire bonding can be used to connect the electrode layers on any one or more of substrates A-C to an external power source or, in some embodiments, one or more of the electrode layers may be electrically connected to each other or shorted. Wire bonding can be implemented at opposite ends of the liquid crystal cells LC1, LC2, e.g., to the right and left of the liquid crystal cells, or can be placed on adjacent edges of the liquid crystal cells, such as the left and top edges, the right and bottom edges, and so forth.

Singulation Process III

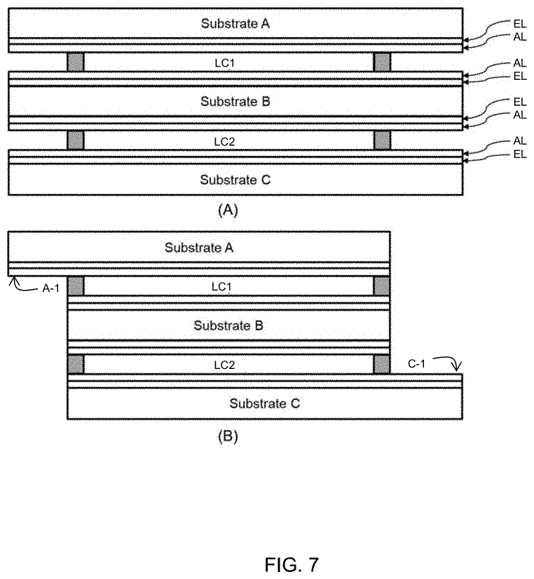

FIG. 7 illustrates an exemplary singulation process for a liquid crystal device comprising three glass substrates A-C. Liquid crystal layer LC1 is positioned between first substrate A and third substrate B, and liquid crystal layer LC2 is positioned between second substrates C and third substrate B. Electrode layers EL and alignment layers AL are illustrated as present on both sides of the liquid crystal layers LC1 and LC2 but, as discussed above, these layers are optional and one or more of layers EL and AL may or may not be present depending on the desired liquid crystal device configuration.

The singulation process illustrated in FIG. 7 comprises two steps. In step (A), all three substrates are cut through to separate them from the motherboard glass assembly (not shown). In step (B), a portion of glass is removed from first and third substrates A and B, to expose an interior surface C-1 of second substrate C, and a portion of glass is removed from second and third substrates C and B, to expose an interior surface A-1 of first substrate A.

In the two-step process of FIG. 7, the first step includes cutting all of substrates A-C and the second step includes cutting through substrates A and B on one side of the liquid crystal cells LC1, LC2 and through substrates B and C on the other side of the liquid crystal cells. The first step (A) can be performed using a laser cutting technique to cut through all glass layers simultaneously or sequentially. The first step (A) can also be performed using a scribe and break technique on the outer substrates A and C and laser cutting on the interstitial substrate B. The second step (B) can be carried out using a laser cutting technique.

While not illustrated, wire bonding can be used to connect the electrode layers on one or both of substrates A and C to an external power source or, in some embodiments, one or more of the electrode layers may be electrically connected to each other or shorted. Wire bonding can be implemented at opposite ends of the liquid crystal cells LC1, LC2, e.g., to the right and left of the liquid crystal cells, or can be placed on adjacent edges of the liquid crystal cells, such as the left and top edges, the right and bottom edges, and so forth.

Singulation Process IV

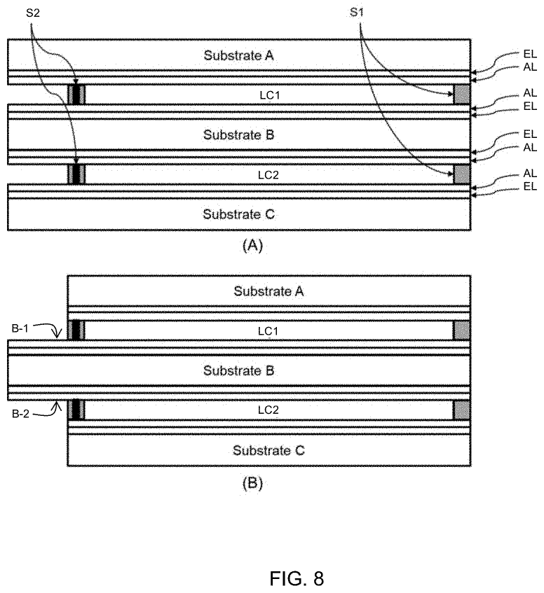

FIG. 8 illustrates an exemplary singulation process for a liquid crystal device comprising three glass substrates A-C. Liquid crystal layer LC1 is positioned between first substrate A and third substrate B, and liquid crystal layer LC2 is positioned between second substrates C and third substrate B. Electrode layers EL and alignment layers AL are illustrated as present on both sides of the liquid crystal layers LC1 and LC2 but, as discussed above, these layers are optional and one or more of layers EL and AL may or may not be present depending on the desired liquid crystal device configuration.

The singulation process illustrated in FIG. 8 comprises two steps. In step (A), all three substrates are cut through to separate them from the motherboard glass assembly (not shown). In step (B), a portion of glass is removed from first and second substrates A and C, to expose interior surfaces B-1, B-2 of third substrate B. The recessed edges of substrates A and C can be aligned and positioned on the same side of the liquid crystal cells, for example, the left side as illustrated, or the recessed edges can be mismatched (not shown), which can provide additional mechanical support to third substrate B.

In the two-step process of FIG. 8, the first step includes cutting all of substrates A-C and the second step includes cutting through substrates A and C on one side of the liquid crystal cells LC1, LC2. The first step (A) can be performed using a laser cutting technique to cut through all glass layers simultaneously or sequentially. The first step (A) can also be performed using a scribe and break technique on the outer substrates A and C and laser cutting on the interstitial substrate B. The first step (A) can also be performed using a dicing saw on the outer substrates A and C and laser cutting on the interstitial substrate B. The second step (B) can be performed using laser cutting, mechanical scribe and break techniques, or a saw, e.g., a dicing saw.

As shown in FIG. 8, the liquid crystal device can comprise both non-conductive seal S1 and conductive seals S2. Conductive seals S2 can comprise, for instance, a localized inclusion of conductive particles embedded into a nonconductive sealant. While not illustrated, the liquid crystal device can also include patterned electrode layer contact pads for wire bonding and electrode traces for powering the electrode layers of substrate B via the conductive seals S2.

Singulation Process V

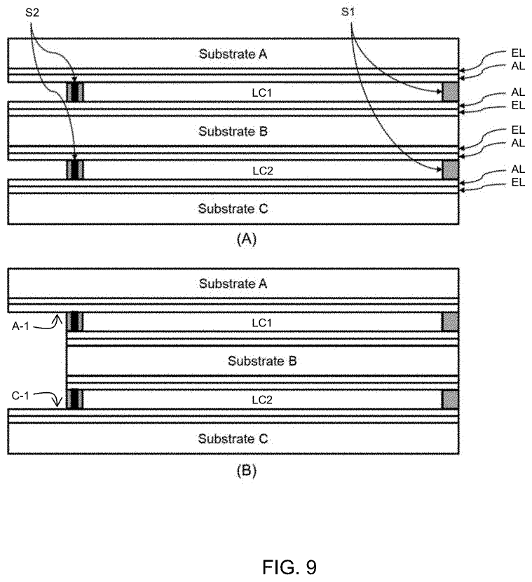

FIG. 9 illustrates an exemplary singulation process for a liquid crystal device comprising three glass substrates A-C. Liquid crystal layer LC1 is positioned between first substrate A and third substrate B, and liquid crystal layer LC2 is positioned between second substrates C and third substrate B. Electrode layers EL and alignment layers AL are illustrated as present on both sides of the liquid crystal layers LC1 and LC2 but, as discussed above, these layers are optional and one or more of layers EL and AL may or may not be present depending on the desired liquid crystal device configuration.

The singulation process illustrated in FIG. 9 comprises two steps. In step (A), all three substrates are cut through to separate them from the motherboard glass assembly (not shown). In step (B), a portion of glass is removed from third substrate B, to expose interior surfaces A-1, C-1 of first and second substrates A and C.

In the two-step process of FIG. 9, the first step includes cutting all of substrates A-C and the second step includes cutting through substrate B on one side of the liquid crystal cells LC1, LC2. The first step (A) can be performed using a laser cutting technique to cut through all glass layers simultaneously or sequentially. The first step (A) can also be performed using a scribe and break technique on the outer substrates A and C and laser cutting on the interstitial substrate B. The second step (B) can be carried out using a laser cutting technique.

As shown in FIG. 9, the liquid crystal device can comprise both non-conductive seal S1 and conductive seals S2. Conductive seals S2 can comprise, for instance, a localized inclusion embedded into a nonconductive sealant. While not illustrated, the liquid crystal device can also include patterned electrode layer contact pads for wire bonding and electrode traces for powering the electrode layers via the conductive seals S2. Wire bonding can be used to connect the electrode layers on one or both of substrates A and C to an external power source or, in some embodiments, one or more of the electrode layers may be electrically connected to each other or shorted.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method that comprises A+B+C include embodiments where a method consists of A+B+C and embodiments where a method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. A method for making a liquid crystal device, the method comprising:
(a) producing a first substrate assembly by:
(i) depositing a first electrode layer on a first surface of a first glass substrate, and
(ii) depositing a first alignment layer on the first electrode layer;
(b) producing a second substrate assembly by:
(i) depositing a second electrode layer on a first surface of a second glass substrate, and
(ii) depositing a second alignment layer on the second electrode layer;
(c) producing a third substrate assembly by:
(i) depositing a third alignment layer on a first surface of a third substrate, and
(ii) depositing a fourth alignment layer on an opposing second surface of the third substrate;
(d) producing a half-cell assembly by:
bringing the first substrate assembly and the third substrate assembly into proximity to define a first cell gap, wherein the first and third substrate assemblies are positioned such that the first alignment layer and third alignment layers face each other;
(ii) filling the first cell gap with liquid crystal material to form a first liquid crystal layer, and
(iii) sealing the first liquid crystal layer;
(e) producing a liquid crystal assembly by:
(i) bringing the second substrate assembly and the half-cell assembly into proximity to define a second cell gap, wherein the second substrate assembly and half-cell assembly are positioned such that the second alignment layer and fourth alignment layers face each other;
(ii) filling the second cell gap with liquid crystal material to form a second liquid crystal layer, and
(iii) sealing the second liquid crystal layer; and
(f) singulating the liquid crystal assembly to produce at least one liquid crystal device.

2. The method of claim 1, further comprising patterning at least one of the first and second electrode layers.

3. The method of claim 1, further comprising rubbing at least one of the first, second, third, and fourth alignment layers to create surface anisotropy.

4. The method of claim 1, wherein the steps of depositing the third and fourth alignment layers on the third substrate are carried out sequentially.

5. The method of claim 1, wherein the steps of depositing the third and fourth alignment layers on the third substrate are carried out simultaneously.

6. The method of claim 1, further comprising rubbing the fourth alignment layer to create surface anisotropy subsequent to the step (d) of producing the half-cell assembly and prior to the step (e) of producing the liquid crystal assembly.

7. The method of claim 1, further comprising depositing a third electrode layer on the first surface of the third substrate prior to depositing the third alignment layer, and depositing a fourth electrode layer on the second surface of the third substrate prior to depositing the fourth alignment layer.

8. The method of claim 1, wherein at least one of steps (d) and (e) further comprises applying spacers to define a thickness of the first or second liquid crystal layer.

9. The method of claim 1, wherein at least one of steps (d) and (e) further comprises applying an adhesive to at least one of the first, second, or third substrates to define an edge seal perimeter and curing the adhesive to seal the first or second liquid crystal layer.

10. The method of claim 1, further comprising curing at least one of the first and second liquid crystal layers.

11. The method of claim 1, wherein singulating the liquid crystal assembly comprises separating the liquid crystal assembly from a motherboard glass assembly.

12. The method of claim 1, wherein singulating the liquid crystal assembly comprises removing at least a portion of at least one of the first, second, or third substrates to define at least one recessed edge in the liquid crystal device.

13. The method of claim 1, wherein singulating the liquid crystal assembly comprises at least one of laser cutting, sawing, and scribe and break techniques.

14. The method of claim 1, further comprising wire bonding the liquid crystal device to connect at least one of the first and second electrode layers to a power source.

15. A method for making a liquid crystal device, the method comprising:
(a) producing a first substrate assembly by depositing a first alignment layer on a first surface of a first glass substrate;
(b) producing a second substrate assembly by depositing a second alignment layer on a first surface of a second glass substrate;
(c) producing a third substrate assembly by:
(i) depositing a first electrode layer on a first surface of a third substrate,
(ii) depositing a third alignment layer on the first electrode layer,
(iii) depositing a second electrode layer on an opposing second surface of the third substrate, and
(ii) depositing a fourth alignment layer on the second electrode layer;
(d) producing a half-cell assembly by:
(i) bringing the first substrate assembly and the third substrate assembly into proximity to define a first cell gap, wherein the first and third substrate assemblies are positioned such that the first alignment layer and third alignment layers face each other;
(ii) filling the first cell gap with liquid crystal material to form a first liquid crystal layer, and
(iii) sealing the first liquid crystal layer;
(e) producing a liquid crystal assembly by:
(i) bringing the second substrate assembly and the half-cell assembly into proximity to define a second cell gap, wherein the second substrate assembly and half-cell assembly are positioned such that the second alignment layer and fourth alignment layers face each other;
(ii) filling the second cell gap with liquid crystal material to form a second liquid crystal layer, and
(iii) sealing the second liquid crystal layer; and
(f) singulating the liquid crystal assembly to produce at least one liquid crystal device.

16. The method of claim 15, further comprising patterning at least one of the first and second electrode layers.

17. The method of claim 15, further comprising rubbing at least one of the first, second, third, and fourth alignment layers to create surface anisotropy.

18. The method of claim 15, wherein the steps of depositing the first and second electrode layers on the third substrate are carried out sequentially or simultaneously.

19. The method of claim 15, wherein the steps of depositing the third and fourth alignment layers on the first and second electrode layers are carried out sequentially or simultaneously.

20. The method of claim 15, further comprising rubbing the fourth alignment layer to create surface anisotropy subsequent to the step (d) of producing the half-cell assembly and prior to the step (e) of producing the liquid crystal assembly.

21. (canceled)

22. (canceled)

23. (canceled)

24. (canceled)

25. (canceled)

26. (canceled)

27. (canceled)

28. (canceled)

29. (canceled)
